(19) United States
(12) Patent Application Publication
(10) Pub. No.: US 2004/0174807 A1
(43) Pub. Date: Sep. 9, 2004

(54) METHOD FOR CO-LAYOUT OF DIFFERENT BUSES IN AN ELECTRIC BOARD

(76) Inventor: Ching-Chih Li, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,768

(22) Filed: Aug. 14, 2003

(30) Foreign Application Priority Data
Mar. 7, 2003 (TW) 092105019

(51) Int. Cl. H04J 1/12

(52) U.S. Cl. 370/201

(57) ABSTRACT

A novel structure for reducing cross-talk effect is disclosed. The structure includes an electric board containing a ground layer and a plurality of adapting modules. Only one of the adapting modules can operates at any one time and each adapting module includes a plurality of slots and a plurality of buses. The plurality of the slots can detachably accommodate a plurality of corresponding adapting devices. The buses are electrically connected to the plurality of slots for transmitting signals and data. When the adapting module does not operate, the corresponding the buses are connected to the ground layer of the electric board. The plurality of the buses of the modules are alternately co-laid out on the electric board.

### BACKGROUND OF INVENTION

1. Field of the Invention

The invention relates to a structure for reducing cross-talk, and more particularly, to a different-buses-co-layout structure utilizing a plurality of non-operating buses as shielding traces to reduce cross-talk.

2. Description of the Prior Art

When a novel technique replaces a conventional technique, there are transitional commercialized products on the market, such as an electric board conforming to both SDR (Single Data Rate) and DDR (Double Data Rate) specifications. To save costs conforming to both the new and old specifications, designers strive to integrate the new and old related devices in one electric board. Taking memory devices in a computer as an example, when DDRII is being promoted and DDRI is not yet phased out, designers will try to integrate the DDR I and the DDR II in the same motherboard. However, when hardware devices and corresponding buses respectively conforming to different specifications are co-laid out in the same motherboard, the cross-talk effect appears and designers have to come up with cost-effective and efficient methods to reduce the cross-talk effect.

Many prior-art patents disclose a ground-shielding characteristic in a structure laid out with buses of the same type. In brief, a plurality of ground traces are interlaced among signal lines with signals transmitted inside so that a ground shielding trace exists between every two signal lines to avoid the signal interference. In U.S. Pat. No. 6,444,922, “Zero cross-talk signal line design”, Kwong et al. etch thin slots at two sides of each signal line on the electric board to form a metal shield around each signal line. However, the above-mentioned prior-art technique will suffer an extremely high cost and not be practical for manufacturing. In addition, increasing the distance between every two signal lines will lead to an enlargement of the electric board and raise the cost.

Please refer to FIG. 1 and FIG. 2. FIG. 1 is a schematic diagram of a layout structure showing the DDR I installed on a motherboard. FIG. 2 is a schematic diagram of a layout structure showing the DDR II installed on a motherboard. The combination of FIG. 1 and FIG. 2 can be viewed as a schematic diagram of a prior-art different-buses-co-layout structure.

In FIG. 1, the DDR I layout structure 10 includes an electric board 12 installed with a ground layer, a plurality of slots 14, and a plurality of buses 16. For sake of clearness of the diagram, only one bus 16 and two slots 14 are shown in FIG. 1. The plurality of slots 14 can be used to detachably accommodate a plurality of corresponding DDR I adapting devices, and the bus 16 is electrically connected to the slot 14 for transmitting signals and data. A resistor Rtt, which is installed at an end of the bus 16 (behind the slot 14) and connected to a voltage Vtt, is used for impedance matching to erase reflecting waves and for reducing rising/falling time of the transmitted signals to increase data-access efficiency.

The DDR II layout structure 20 shown in FIG. 2 also includes an electric board 22 installed with a ground layer, a plurality of slots 24, and a plurality of buses 26. Similar to the embodiment shown in FIG. 1, only one bus 26 and two slots 24 are shown in FIG. 2. Please notice that the electric board 12 of the DDR I layout structure 10 shown in FIG. 1 is the same as the electric board 22 of the DDR II layout structure 20 shown in FIG. 2. In addition, the plurality of buses 16 in the DDR I layout structure 10 and the plurality of buses 26 in the DDR II layout structure 20 are alternately co-laid out in the same electric board. Therefore, the combination of FIG. 1 and FIG. 2 can be viewed as a schematic diagram of a different-buses-co-layout structure according to the prior art. Moreover, the resistor Rtt in the DDR I layout structure 10 shown in FIG. 1 can be integrated into the whole structure of the DDR II layout structure 20 for erasing reflecting waves and for reducing rising/falling time of the transmitted signals to increase data-access efficiency.

Please continue to refer to both FIG. 1 and FIG. 2. The DDR I layout structure 10 and the DDR II layout structure 20 respectively include a DDR I controller 18 and a DDR II controller 28. The DDR I controller 18 and the DDR II controller 28 are respectively used to control operations of the DDR I layout structure 10 and the DDR II layout structure 20. When the DDR I layout structure 10 operates, the prior-art DDR II controller 28 of the DDR II layout structure 20 will be electrically connected to the ground layer of the electric board 22. However, the slots 24 (two slots 24 shown in FIG. 2) in the DDR II layout structure 20 are not connected to the ground layer. As such, the “ungrounded” slots 24 shown in FIG. 2 will operate as antennas to receive signals from the buses 16 in the DDR I layout structure 10 and to emit related signals to interfere with the transmitted signals in the neighboring buses 16 in the DDR I layout structure 10. Similarly, when the DDR 11 layout structure 20 operates, the DDR I layout structure 10 is not totally grounded and will interfere with the original transmitted signals to cause serious cross-talk effect.

### SUMMARY OF INVENTION

It is therefore a primary objective of the claimed invention to provide a structure for reducing cross-talk among adjacent signals by utilizing a plurality of non-operating buses as shielding traces and to solve the above-mentioned problems.

According to the claimed invention, a structure for reducing cross-talk includes an electric board having a ground layer. A plurality of adapting modules are installed on the electric board such that only one adapting module operates at a time. Each adapting module has a plurality of slots for detachably accommodating a plurality of corresponding adapting devices and a plurality of buses electrically connected to the plurality of slots for transmitting signals and data. The plurality of buses of the plurality of adapting modules are alternately laid out on the electric board. When the adapting module does not operate, the corresponding plurality of buses are electrically connected to the ground layer of the electric board.

The claimed invention provides a method for reducing cross-talk in a different-buses-co-layout structure. The different-buses-co-layout structure comprises a plurality of buses for transmitting different types of signals and data. The method includes alternately laying out a plurality of buses of different types on an electric board, utilizing buses of only one type to transmit signals and data at any given time, and electrically connecting two ends of each bus not transmitting signals and data to a ground layer of the electric board.

According to the claimed invention, a different-buses-co-layout structure for reducing cross-talk includes an electric board having a ground layer and a first adapting module and a second adapting module installed on the electric board. The two adapting modules cannot operate at the same time. Each adapting module includes a controller for controlling operations of the adapting modules. The controller has a MOS circuit for switching the controller between a predetermined voltage mode and a ground voltage mode so that when the adapting module does not operate, the MOS circuit switches the controller to the ground voltage mode. Each adapting module also includes a plurality of slots for detachably accommodating a plurality of corresponding adapting devices and a plurality of buses electrically connected to the plurality of slots for transmitting signals and data. The plurality of buses of the two adapting modules are alternately laid out on the electric board. When the adapting module does not operate, the corresponding plurality of buses is electrically connected to the ground layer of the electric board.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a layout structure showing the DDR I installed on a motherboard.

FIG. 2. is a schematic diagram of a layout structure showing the DDR II installed on a motherboard.

FIG. 3 is a schematic diagram showing two similar memory devices and corresponding buses of different types are co-laid out on the same electric board.

FIG. 4 is a schematic diagram of a practical embodiment of the structure shown in FIG. 3.

FIG. 5 is a flow chart of a method of the present invention related to the embodiment shown in FIG. 3.

FIG. 6 is a schematic diagram of an embodiment of a step shown in FIG. 5.

FIG. 7 is a schematic diagram of an embodiment of another step shown in FIG. 5.

### DETAILED DESCRIPTION

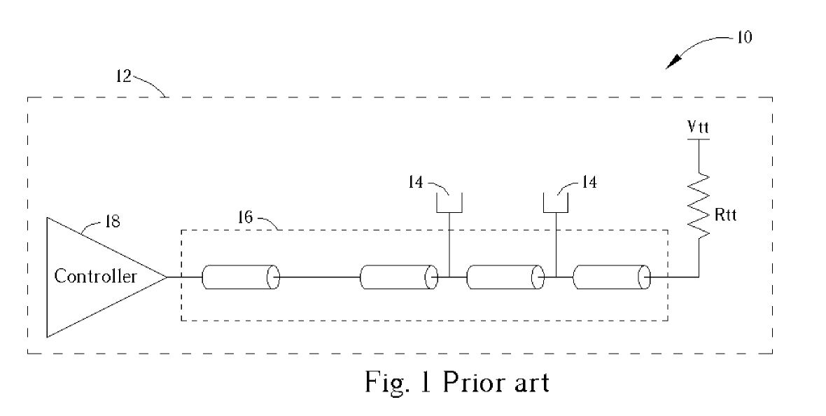

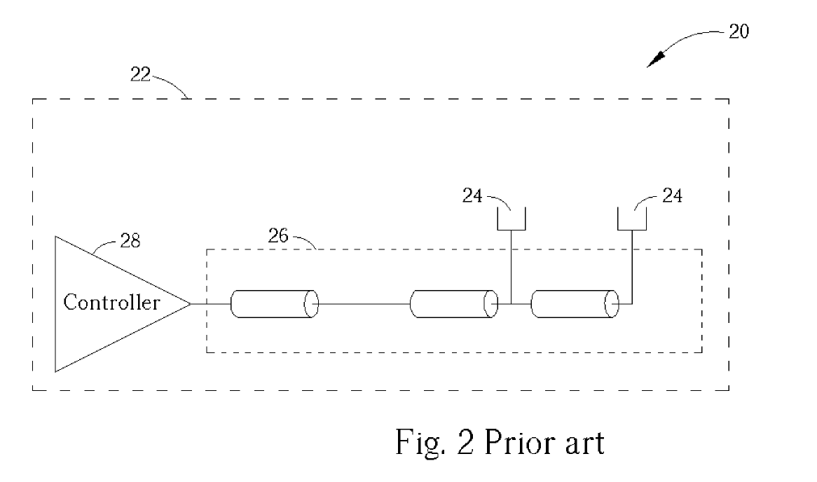

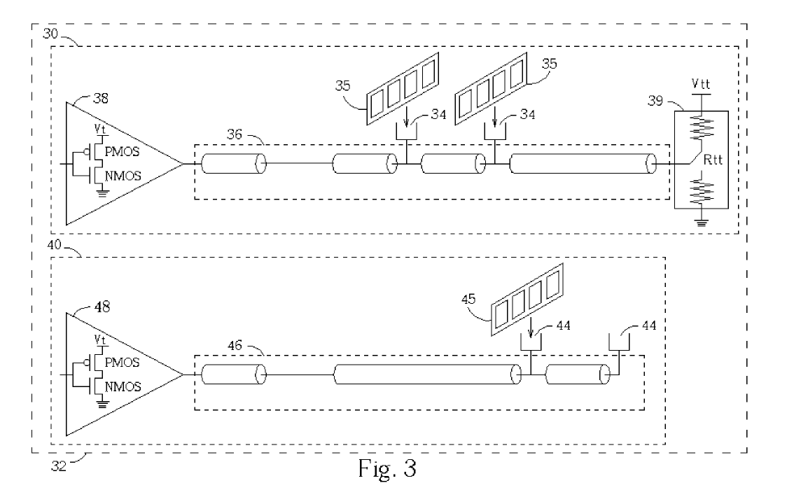

The structure and method used for reducing cross-talk of the present invention is mainly applied in a different-buses-co-layout structure, in which a plurality of similar hardware devices and corresponding buses of different types are co-laid out on the same electric board. Please refer to FIG. 3 which is a schematic diagram showing two similar memory devices and corresponding buses of different types are co-laid out on the same electric board. The present embodiment inherits partial characteristics of the prior-art embodiments shown in FIG. 1 and FIG. 2.

Please refer to FIG. 3. The present embodiment includes two adapting modules 30, 40 installed on an electric board 32. Please notice that these two adapting modules 30, 40 do not operate simultaneously. The two adapting modules 30, 40 are respectively a DDR I layout structure 30 and a DDR II layout structure 40. The DDR I and DDR II layout structures 30, 40 jointly include the electric board 32 installed with a ground layer, and the DDR I and DDR II layout structures 30, 40 respectively include a plurality of slots 34, 44 and a plurality of buses 36, 46. For sake of clearness of the diagram (FIG. 3), only one bus 36 and two slots 34 are shown in the DDR I layout structure 30, and only one bus 46 and two slots 44 are shown in the DDR II layout structure 40.

Please refer to the DDR I layout structure 30 first, the two slots 34 can be used to detachably accommodate two corresponding DDRI adapting devices 35, and the bus 36 is connected to the two slots 34 for transmitting signals and data. The DDR I layout structure 30 further includes a DDR I controller 38 for controlling operations of the adapting modules 30 and the DDR I layout structure 30. The DDR I controller 38 includes a MOS circuit, which is composed of a PMOS transistor and a NMOS transistor for switching the DDR I controller 38 between a predetermined voltage mode Vt and a ground voltage mode. In addition, a switch 39 is installed at the end of the bus 36 (behind the slot 34) for switching the end of the bus 36 of the DDRI-adapting devices 35 between a predetermined voltage mode Vtt and a ground voltage mode. When being practically implemented, the resistor Rtt shown in FIG. 1 for impedance matching can be included in the switch 39.

Please refer to the DDR II layout structure 40. The DDR II layout structure 40 includes a plurality of slots 44, and a plurality of buses 46. Similar to the embodiment of the DDR I layout structure 30, only one bus 46 and two slots 44 for accommodate corresponding DDRIIadapting devices 45 are shown. The DDR II layout structure 40 also includes a DDR II controller 48 for controlling operations of the adapting modules 40 and the DDR I layout structure 40. The DDR II controller 48 still makes use of a MOS circuit to switch the DDR II controller 48 between a predetermined voltage mode Vt and a ground voltage mode.

Please notice that the DDR I layout structure 30 and the DDR II layout structure 40 jointly make use of the electric board 32, and the buses 36 of the DDR I layout structure 30 and the buses 46 of the DDR II layout structure 40 are alternately laid out on the electric board 32.

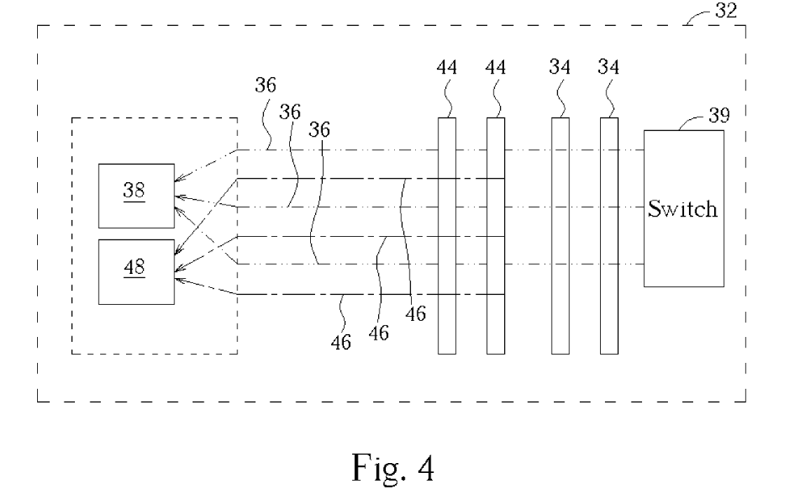

Please refer to FIG. 4, which is a schematic diagram of a practical embodiment of the structure shown in FIG. 3. When the DDR I layout structure 30 operates, the buses 36 of the DDR I layout structure 30 are used to transmit signals and data. However, due to the fact that the buses 36 and the buses 46 are alternately laid out on the same electric board 32, the transmitted signals in the bus 36 of the DDR I layout structure 30 will interfere with the neighboring buses 46 of the DDR II layout structure 40. In addition, related electro-magnetic waves will return to interfere with the bus 36 with signals transmitted inside the buses 46. Similarly, when the DDR II layout structure 40 operates, cross-talk will happen.

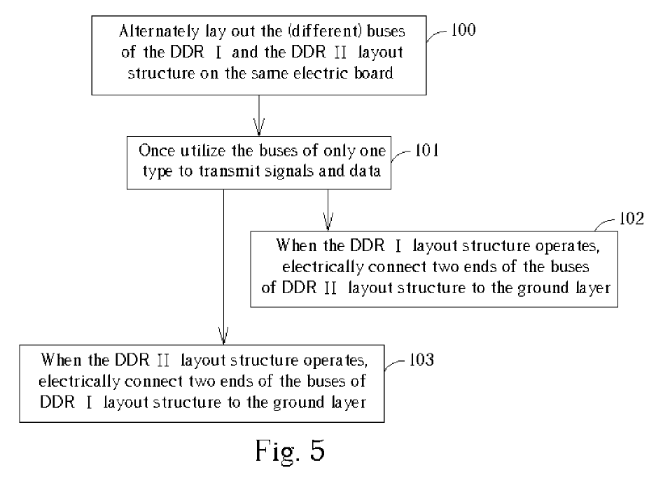

The above-mentioned embodiment of the present invention can make use of ground shielding to eliminate cross-talk, and the basic principle is as follows. Please refer to FIG. 5, which is a flow chart of a method of the present invention related to the embodiment shown in FIG. 3.

Step 100: Alternately lay out the buses 36 of the DDR I layout structure 30 and the bus 46 of the DDR II layout structure 40 on the electric board 32.

Step 101: Utilize the buses 36 or the buses 46 (corresponding to the DDR I or DDR II) to transmit signals and data, that is, the two adapting modules 30, 40 do not operate at the same time.

Step 102: When the DDR I layout structure operates, electrically connect two (terminal) ends of the buses 46 of DDR II layout structure to the ground layer of the electric board 32 to reduce cross-talk among the buses 36.

Step 103: When the DDR II layout structure operates, electrically connect two (terminal) ends of the buses 36 of DDR I layout structure to the ground layer of the electric board 32 to reduce cross-talk among the buses 46.

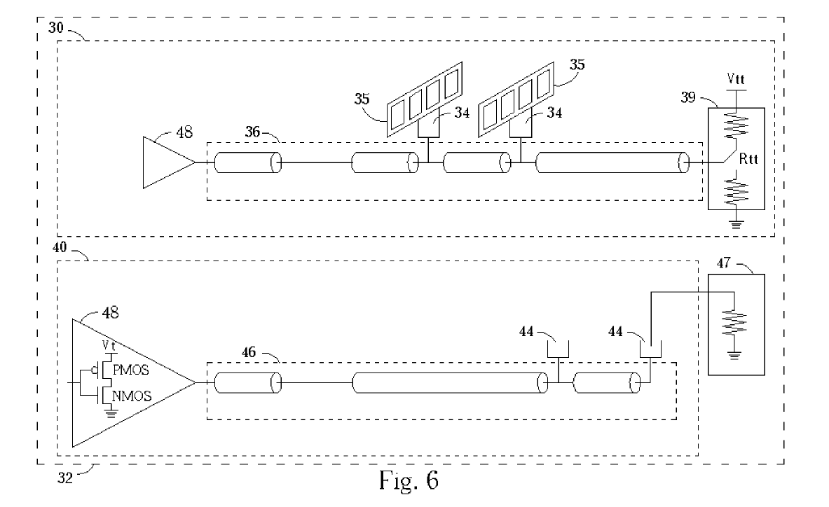

Please refer to FIG. 6, which is a schematic diagram of an embodiment of the step 102 shown in FIG. 5. When the DDR I layout structure 30 operates (the slot 34 is installed with corresponding DDRIadapting devices 35), the switch 39 of the DDR I layout structure 30 will be connected to the predetermined voltage Vtt. In the non-operating DDR II layout structure 40, the slot 44 closest to the (terminal) end of the bus 46 is installed with a terminator card 47, which can connect the slot 44 to the ground layer of the electric board 32. In the meantime, the MOS circuit of the DDR II controller 48 connects the DDR II controller 48 to the ground voltage (the PMOS transistor switches off and the NMOS transistor switches on), so that all the related traces of the DDR II layout structure 40 in the electric board 32 are grounded. In addition, due to the fact that the terminator card 47 is installed in the slot 44 closest to the (terminal) end of the bus 46, the bus 46 can be totally grounded to form a shielding trace to block any cross-talk.

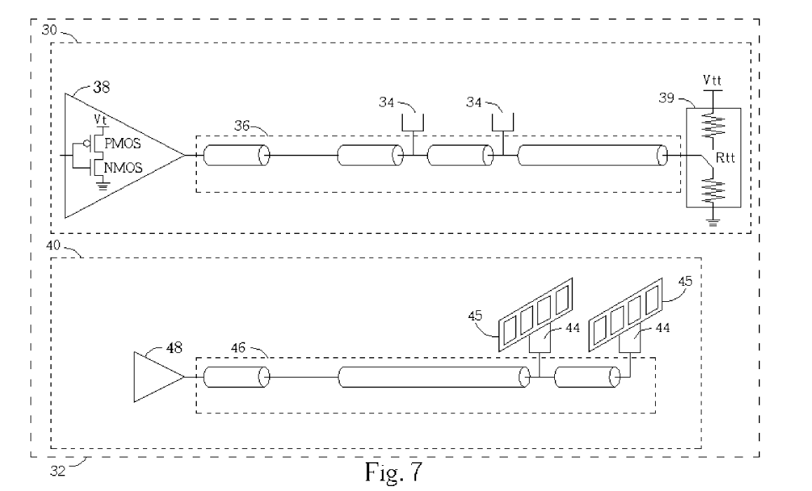

Please refer to FIG. 7, which is a schematic diagram of an embodiment of the step 103 shown in FIG. 5. When the DDR II layout structure 40 operates (the slot 44 is installed with corresponding DDRIIadapting devices 45), the switch 39 of the non-operating DDR I layout structure 30 will be connected to the ground voltage and the MOS circuit of the DDR I controller 38 will connect the DDR I controller 38 to the ground voltage (the PMOS transistor switches off and the NMOS transistor switches on) so that all the related traces of the DDR I layout structure 30 in the electric board 32 are grounded.

The above-mentioned embodiments employ two adapting modules (the DDR I layout structure 30 and the DDR II layout structure 40). However, when being practically implemented, the quantity of the adapting modules, the slots, and the buses should not be limited. The major characteristic of the present invention is to co-lay out buses of different types on the same electric board and to connect two ends of each non-operating bus to a ground layer of the electric board to form shielding traces to reduce cross-talk. Therefore, when different buses are co-laid out on the same electric board, there is no need to increase the distance between sets of buses and raising the cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A structure for reducing cross-talk comprising:
an electric board comprising a ground layer; and
a plurality of adapting modules installed on the electric board, wherein only one of the adapting module can operate at a time; each adapting module comprising:
a plurality of slots for detachably accommodating a plurality of corresponding adapting devices; and
a plurality of buses electrically connected to the plurality of slots for transmitting signals and data, wherein when the adapting module does not operate, the corresponding plurality of buses are electrically connected to the ground layer of the electric board;
wherein the plurality of buses of the plurality of adapting modules are alternately laid out on the electric board.

2. The structure of claim 1 wherein ends of a plurality of buses of at least an adapting module comprise a switch corresponding to the adapting modules for switching the ends of the plurality of buses between a predetermined voltage mode and a ground voltage mode.

3. The structure of claim 2 wherein when the adapting module does not operate, the switch corresponding to the adapting module switches the ends of the plurality of buses into the ground voltage mode, so that the plurality of buses are electrically connected to the ground layer of the electric board.

4. The structure of claim 1 wherein at least one of the plurality of slots of at least one adapting module is detachably installed with at least a terminator card for electrically connecting the plurality of slots installed with the terminator card to the ground layer of the electric board.

5. The structure of claim 4 wherein when the adapting module does not operate, the plurality of slots corresponding to the non-operating adapting module is installed with at least a terminator card for electrically connecting the plurality of slots installed with the terminator card to the ground layer of the electric board.

6. The structure of claim 1 wherein each adapting module comprises a controller for controlling operations of the adapting modules.

7. The structure of claim 6 wherein the controller comprises a MOS circuit for switching the controller between a predetermined voltage mode and a ground voltage mode.

8. The structure of claim 7 wherein when the adapting module does not operate, the MOS circuit switches the controller to the ground voltage mode.

9. The structure of claim 1 being applied in a motherboard of a personal computer.

10. A method for reducing cross-talk in a different-buses-co-layout structure, the different-buses-co-layout structure comprising a plurality of buses for transmitting different types of signals and data, the method comprising:
alternately laying out different types of the plurality of buses on an electric board;
utilizing buses of only one type to transmit signals and data; and
electrically connecting two ends of each bus not transmitting signals and data to a ground layer of the electric board.

11. The method of claim 10 wherein the different-buses-co-layout structure comprises a plurality of adapting modules, wherein each adapting module corresponds a plurality of buses of one type, the method further comprises operating only one adapting module.

12. The method of claim 11 wherein each adapting module comprises:
a plurality of slots for detachably accommodating a plurality of corresponding adapting devices; and
a controller for controlling operations of the adapting modules, the controller comprising a MOS circuit for switching the controller between a predetermined voltage mode and a ground voltage mode;
the method further comprising:
installing at least a terminator card into the plurality of slots of the adapting module that does not operate so that the plurality of slots installed with the terminator card is electrically connected to the ground layer of the electric board; and
utilizing the MOS circuit to switch the controller of the adapting module that does not operate to the ground voltage mode so that the controller is electrically connected to the ground layer of the electric board.

13. The method of claim 11 wherein ends of the plurality of buses of the adapting module comprise a switch corresponding to the adapting module for switching the plurality of ends between a predetermined voltage mode and a ground voltage mode.

14. The method of claim 13 further comprising utilizing the switch to switch the ends of the plurality of buses corresponding to the adapting module which does not operate to the ground voltage so that the ends of the plurality of buses are electrically connected to the ground layer of the electric board.

15. The method of claim 10 wherein the different-buses-co-layout structure is applied in a motherboard of a personal computer.

16. A different-buses-co-layout structure for reducing cross-talk comprising:
an electric board comprising a ground layer; and
two adapting modules installed on the electric board comprising a first adapting module and a second adapting module, wherein the two adapting modules cannot operate at the same time, each adapting module comprising:
a controller for controlling operations of the adapting modules, the controller comprising a MOS circuit for switching the controller between a predetermined voltage mode and a ground voltage mode wherein when the adapting module does not operate, the MOS circuit switches the controller to the ground voltage mode;
a plurality of slots for detachably accommodating a plurality of corresponding adapting devices; and
a plurality of buses electrically connected to the plurality of slots for transmitting signals and data, wherein when the adapting module does not operate, the corresponding plurality of buses are electrically connected to the ground layer of the electric board;
wherein the plurality of buses of the two adapting modules are alternately laid out on the electric board.

17. The different-buses-co-layout structure of claim 16 wherein ends of the plurality of buses of the first adapting module comprise a switch for switching the ends of the plurality of buses of the first adapting module between the predetermined voltage mode and the ground voltage mode.

18. The different-buses-co-layout structure of claim 17 wherein when the first adapting module does not operate, the switch corresponding to the first adapting module switches the ends of the plurality of buses into the ground voltage mode, so that the plurality of buses are electrically connected to the ground layer of the electric board.

19. The different-buses-co-layout structure of claim 16 wherein the plurality of slots of the second adapting module is detachably installed with at least a terminator card for electrically connecting the plurality of slots installed with the terminator card to the ground layer of the electric board.

20. The different-buses-co-layout structure of claim 19 wherein when the second adapting module does not operate, the plurality of slots corresponding to the second adapting module are installed with at least a terminator card for electrically connecting the plurality of slots installed with the terminator card to the ground layer of the electric board.

21. The different-buses-co-layout structure of claim 16 being applied in a motherboard of a personal computer.
